(19) United States
(12) Patent Application Publication
(10) Pub. No.: US 2013/0187555 A1
(43) Pub. Date: Jul. 25, 2013

(54) Flicker-Free LED Driver Circuit with High Power Factor

(71) Applicant: Luxul Technology Incorporation, New Taipei City (TW)

(72) Inventors: Cheng-Hung Pan, New Taipei City (TW); Perng-Fei Yuh, New Taipei City (TW)

(73) Assignee: LUXUL TECHNOLOGY INCORPORATION, New Taipei City (TW)

(21) Appl. No.: 13/736,660

(22) Filed: Jan. 8, 2013

(30) Foreign Application Priority Data
Jan. 20, 2012 (TW) 101102578

(51) Int. Cl. H05B 33/08

(52) U.S. Cl. CPC H05B 33/0842
USPC 315/188; 315/201

(57) ABSTRACT

A flicker-free LED driver circuit with a high power factor has a rectifying unit connected with an AC power source, an LED module connected in series with the rectifying unit, a capacitor module connected in parallel with the LED module, and a constant current circuit connected in series with the LED module and the capacitor module. When the voltage output by the rectifying unit is smaller than a junction voltage of the LED module, the capacitor module discharges to the LED module so that the LED module does not go out, thereby eliminating the flickering. The input impedance of the rectifying unit can be regarded as a capacitive reactance element connected in parallel with a nonlinear resistive element. The internal resistance of the constant current source approaches infinity. Therefore, the power factor of the flicker-free LED driver circuit approximates 1, achieving a high power factor.

### CROSS-REFERENCE TO RELATED APPLICATIONS

This application claims the benefit of Taiwan patent application No. 101102578, filed on Jan. 20, 2012, the disclosure of which is incorporated herein in its entirety by reference.

### BACKGROUND OF THE INVENTION

1. Field of the Invention

The invention relates to an AC LED driver circuit and, in particular, to a flicker-free LED driver circuit with a high power factor.

2. Description of Related Art

The light-emitting diode (LED) is one of the most common lighting appliances currently available on the market. In comparison with the traditional incandescent light bulbs, LED has higher luminous efficiency and power-saving features. However, the LED is conductive only in a single direction and thus therefore difficult to be used on the conventional AC outlet. For this, the industry has developed an AC LED driver circuit. As shown in FIG. 6, the conventional AC LED driver circuit contains: a rectifying unit 20, an LED module 21, and a constant current circuit 22.

The input terminal of the rectifying unit 20 connects to an AC power supply AC/IN and converts the AC power supply AC/IN into a pulsed DC power supply Va, which is then output via the output terminal.

The LED module 21 includes a plurality of LED light sources and electrically connects to the output terminal of the rectifying unit 20 to constitute a power loop.

The constant current circuit 22 is connected in series to the power loop, such that the circuit current therein has a constant value.

As seen from the above-mentioned structure, the conventional AC LED driver circuit uses the rectifying unit 20 to convert the AC power supply AC/IN into a pulsed DC power supply. The constant current circuit 22 stabilizes the circuit current.

Please refer to FIGS. 7A and 7B. When the pulsed DC power supply Vₐ output by the rectifying unit 20 is greater than junction voltage value Vₜ of the LED module, the voltage difference V_{ab} on both ends of the LED module 21 is controlled at a default value as the circuit current is stably controlled at a default value. The LED module 21 illuminates stably.

However, the voltage difference V_{ab} on both ends of the LED module 21 has to be larger than its junction voltage value in order to emit light. If the instantaneous voltage of the pulsed DC power supply Vₐ is less than the junction voltage value, the LED module turns off, resulting in flickering on the LED module 21. Take pulsed DC power supply with a frequency of 120 Hz as an example. The flickering frequency is also 120 Hz. Human eyes are not sensitive to such flickering at the frequency of 120 Hz, but for an image capture device that performs periodic scans, images captured under a light source flickering at the frequency of 120 Hz have flickering effects due to the difference between the scanning frequency and the light source frequency. The net result is that the images have a plurality of parallel stripes, leading to distortions in the photos.

Therefore, to solve the above-described flickering problem, as shown in FIG. 8, the most intuitive approach is to directly connect a capacitor 23 in parallel to the rectifier unit 20, so that the pulsed DC power supply becomes a DC power supply with a stable output. However, this approach reduces the power factor of the conventional LED driver circuit. Please refer to FIG. 9. The reason is that the signal output by the rectifying unit 20 is an AC/DC mixed pulsed DC signal. The input impedance of the capacitor 23 Rᵢₙ=X_{C}//(R+RI), wherein X_{C} is the capacitive reactance of the capacitor 23, R is the effective non-linear impedance of the LED module, and RI is the effective electric current source impedance of the constant current circuit 22. From the above input impedance Rᵢₙ formula, the power factor can be derived as X_{C}/(X_{C}+R+RI). Since the capacitance value of a normal capacitor is far less than the effective impedance RI of the constant current source, the above formula shows that although adding this capacitor 23 solves the flickering problem, the input impedance Rᵢₙ is capacitive, thereby lowering the power factor.

### SUMMARY OF THE INVENTION

In view of the foregoing, an objective of the invention is to provide a flicker-free LED driver circuit with a high power factor.

To achieve the above-mentioned objective, the flicker-free LED driver circuit with a high power factor includes: a rectifying unit, an LED module, a capacitor module, and a constant current circuit.

The input terminal of the rectifying unit connects to an AC power supply, and converts the AC power into a pulsed DC power supply, which is then output by the output terminal.

The LED module includes a plurality of LED light sources, and electrically connects to the output terminal of the rectifying unit, thereby constituting a power loop.

The capacitor module includes at least one capacitor connected in parallel with the LED module.

The constant current circuit is connected in series with the power loop to render a constant value for the current in the power loop.

As seen from the foregoing structure, for the signal output by the rectifying unit, the input impedance can be regarded as that of a capacitive reactance element constituted by the capacitor module connected in parallel with a nonlinear resistive element constituted by the LED module, followed by a serial connection with a constant current source constituted by the constant current circuit. Since the effective internal resistance of the constant current circuit is infinity, the effective impedance is always infinite no matter how the capacitive reactance element or the resistive element changes. Therefore, the computed actual power is very close to the effective power, with the power factor approximating 1.

Therefore, the invention can effectively solve the flickering problem with the above-mentioned structure without decreasing the power factor.

### BRIEF DESCRIPTION OF THE DRAWINGS

FIG. 1 is a circuit diagram of the flicker-free LED driver circuit with a high power factor of the present invention;

FIGS. 2A to 2E are circuit diagrams of the LED module and capacitor module of the present invention;

FIG. 3A is a waveform diagram of the potentials on the two ends of the LED module according to the invention of the present invention;

FIG. 3B is a waveform diagram of the voltage difference on the LED module of the present invention;

FIG. 4 is a circuit diagram of the effective input impedance of the present invention;

FIG. 5 is a circuit diagram of another embodiment of the invention;

FIG. 6 is a circuit diagram of a conventional AC LED driver circuit;

FIG. 7A is a waveform diagram of the potentials on the two ends of the conventional LED module;

FIG. 7B is a waveform diagram of the voltage difference on the conventional LED module;

FIG. 8 is a circuit diagram of a conventional circuit connected in parallel with a capacitor; and

FIG. 9 is a circuit diagram of the effective input impedance in the conventional circuit.

### DETAILED DESCRIPTION OF THE PREFERRED EMBODIMENT

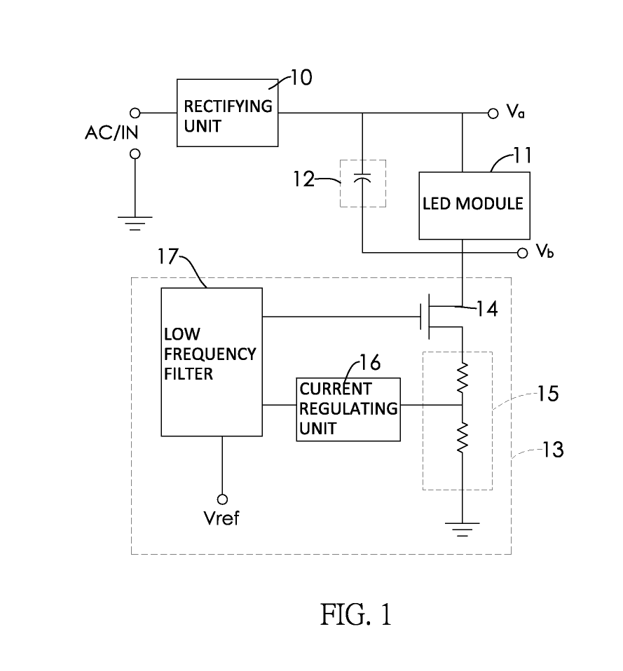

FIG. 1 shows the flicker-free LED driver circuit with a high power factor. The circuit comprises a rectifying unit 10, an LED module 11, a capacitor module 12, and a constant current circuit 13.

The input terminal of the rectifying unit 10 connects to an AC power supply AC/IN, and converts the AC power supply AC/IN into a pulsed DC power supply, which is then output by the output terminal thereof. The rectifying unit 10 can be a full-wave rectifying circuit or a half-wave rectifying circuit. In this embodiment, it is a full-wave rectifying circuit.

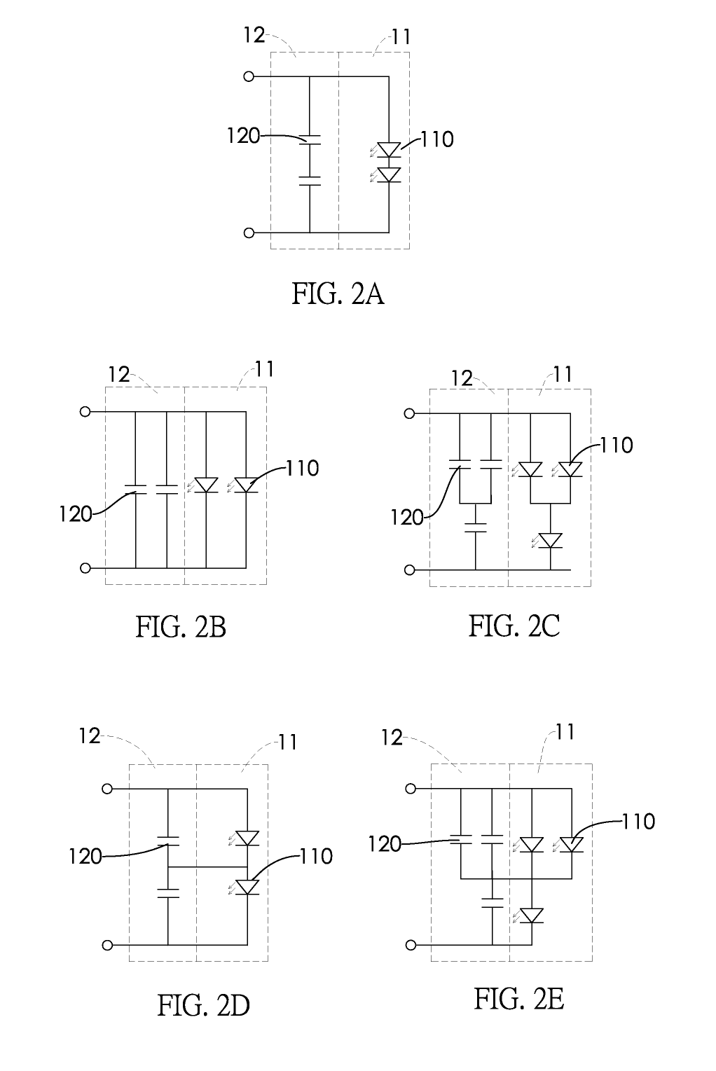

The LED module 11, as shown in FIGS. 2A to 2C, includes a plurality of LED light sources 110, and electrically connects to the output terminal of the rectifying unit to constitute a power loop. In this embodiment, the LED light sources are connected in parallel, in series, or in both series and parallel before connecting to the output terminal of the rectifying unit 10 to constitute a power loop. In this case, the pulsed DC power supply output by the rectifying unit 10 can drive the LED module 11 to emit light.

The capacitor module 12 includes at least one capacitor 120 connected in parallel with the LED module 11. In this embodiment, there are multiple capacitors 120 connected in series, in parallel, or in both series and parallel.

The constant current circuit 13 is connected in series to the power loop to keep the circuit current in the power loop at a constant value. In this embodiment, the constant current circuit 13 includes: a voltage controlled transistor 14, a current detection unit 15, a low frequency filter 17, and a current regulating unit 16.

The voltage-controlled transistor 14 is connected in series to the power loop and has a control terminal to adjust the circuit current of the above-mentioned power loop. The voltage-controlled transistor 14 in this embodiment is a metal oxide field effect transistor (MOSFET) or a bipolar junction transistor (BJT).

The current detection unit 15 is connected in series to the power loop to convert the circuit current of the power loop to a corresponding voltage signal. The current detection unit in this embodiment is a detection resistor.

The low frequency filter 17 electrically connects to the current detection unit 15, and outputs an average voltage value according to the voltage signal of the current detecting unit 15 after the conversion. The low frequency filter 17 can be an analog filter consisted of capacitors and inductors or a digital filter consisted of a digital circuit. In this embodiment, it is a digital filter, which is a down-sampling filter.

One input terminal of the current regulating unit 16 connects to the low frequency filter 17. The other input terminal electrically connects to a reference voltage Vref. The output terminal thereof electrically connects to the control terminal of the voltage-controlled transistor 14. The current regulating unit 16 compares the reference voltage received by the input terminal thereof and the average voltage value, and outputs a control signal based on the comparison result to the control terminal of the voltage-controlled transistor 14, so that the circuit current of the power loop remains stable.

With reference to FIGS. 2D and 2E, the capacitors 120 of the capacitor module 12 are connected in parallel with the LED light sources 110 of the LED module 11.

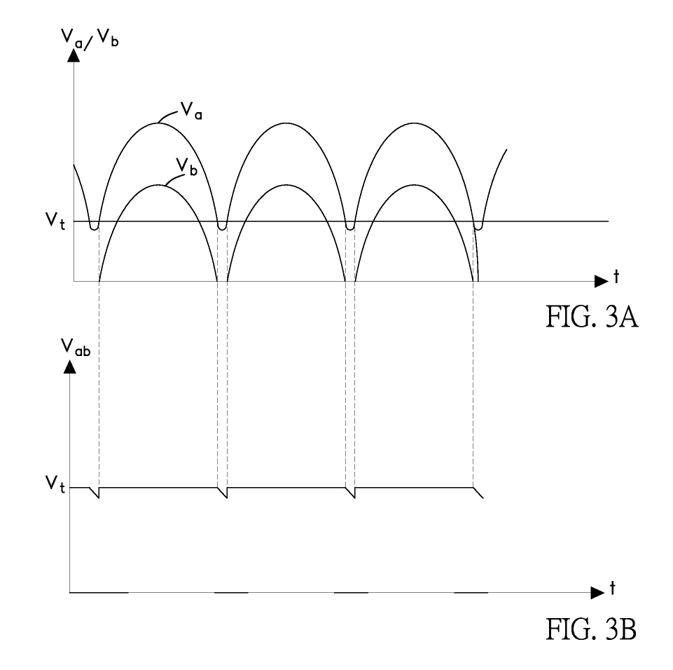

Please refer to FIGS. 3A and 3B. When the pulsed DC power supply Vₐ output by the rectifying unit 10 is greater than the junction voltage Vₜ of the LED module 11, the circuit current is stabilized by the constant current circuit 13 to a default value, so that the LED module 11 emits light stably and the capacitor module 12 is charged at the same time. When the instantaneous voltage of the pulsed DC power supply Vₐ is smaller than the junction voltage Vₜ thereof, the capacitor module 12, as it is connected in parallel with the LED module 11, discharges to the LED module 11 such that the LED module 11 does not go off.

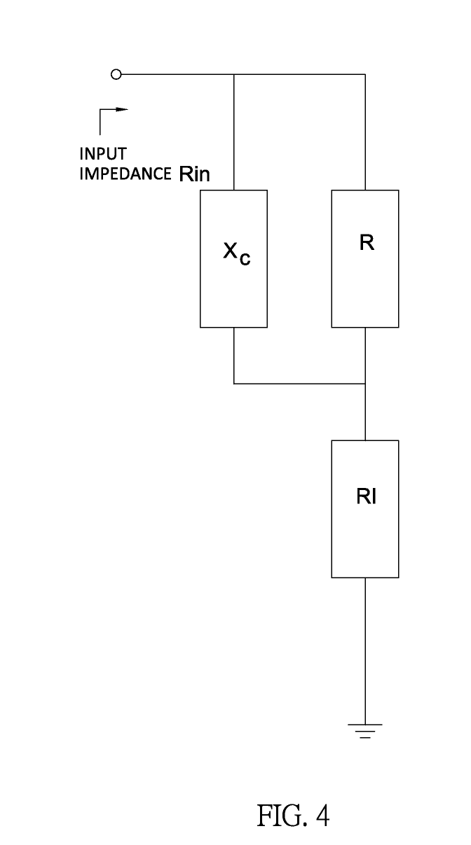

Please refer to FIG. 4. The input impedance of the capacitor module 12 Rᵢₙ=(X_{C}//R)+RI, where X_{C} is the capacitive reactance of the capacitor module 12, R is the effective nonlinear impedance of the LED module 11, and RI is the effective electric current source impedance of the constant current circuit 13. From the above formula for the input impedance Rᵢₙ, the power factor formula can be derived as:

$$\frac{{X}_{C} / ( {X}_{C} + R ) ( R // {X}_{C} ) + RI}{( R // {X}_{C} ) + RI}$$

Since the effective internal resistance RI of the constant current source is far greater than the capacitive reactance Xc of the capacitor module 12, the power factor thus computed approximates 1.

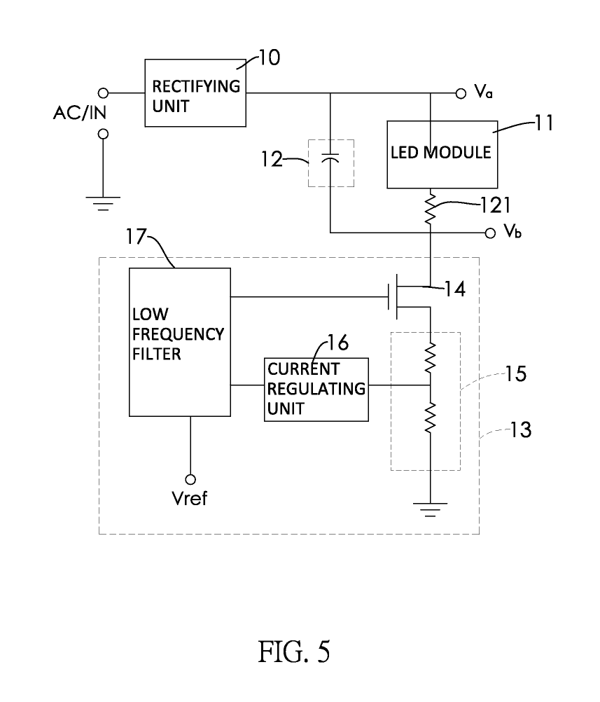

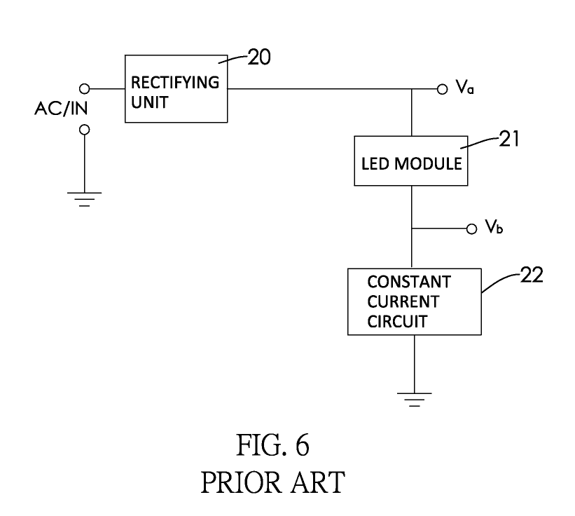

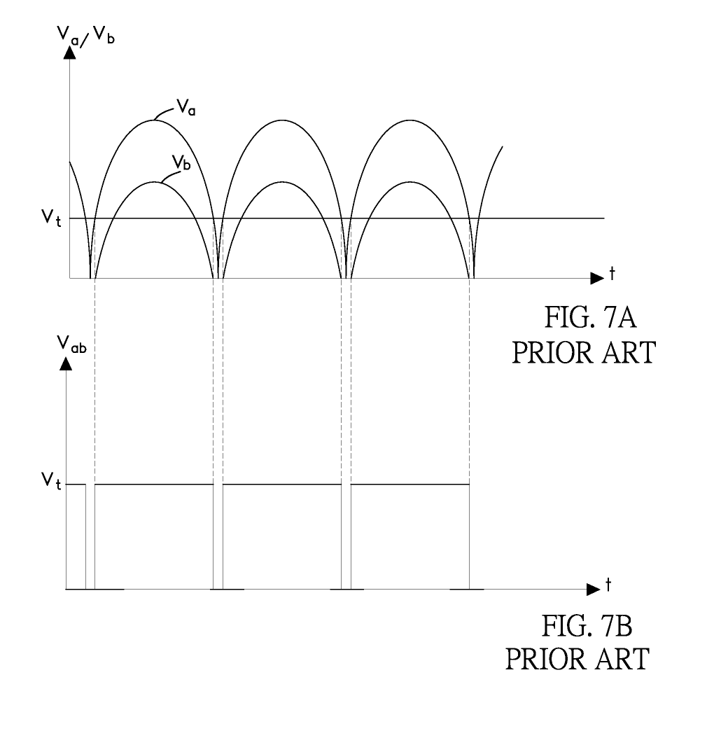

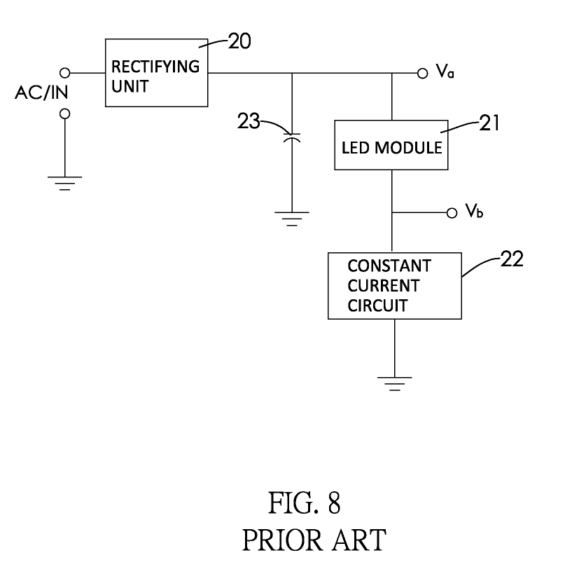

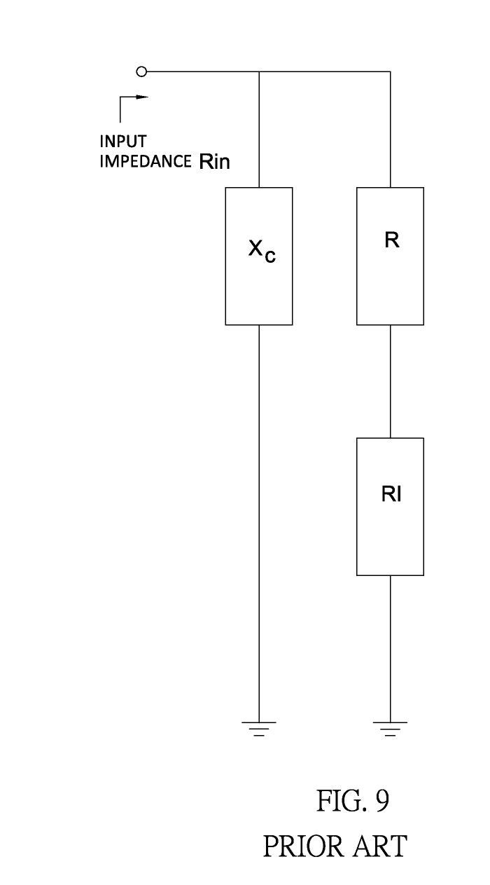

Please refer to FIG. 5. As the internal resistance of each of the LED light sources 110 of the LED module 11 is fairly small, a capacitor module 12 with a larger capacitance has to be adopted in order for the LED module 11 to discharge via the capacitor module 12 and continuously emit light. As capacitors with larger capacitance values are normally also larger in size, the LED module connects in series with a current restricting resistor 121 to reduce the volume of the capacitor module 12. The electric current flowing through the current restricting resistor 121 is not smaller than the lowest driving current of the LED module. This increases the discharge time of the capacitor module 12, so that the volume of the capacitor module 12 can be reduced in the premise that the LED module 11 can stably emit light.

In summary, the invention can effectively solve the problem of flickering by the proposed structure and totally avoids the problem of a decreasing power factor in a traditional circuit when the rectifying unit is connected in parallel with a capacitor.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A flicker-free LED driver circuit with a high power factor, comprising:
a rectifying unit having an input end connected to an AC power supply for converting AC power into pulsed DC power and outputting the pulsed DC power via an output terminal of the rectifying unit;
an LED module including a plurality of LED light sources and electrically connecting to the output terminal of the rectifying unit, thereby forming a power loop;
a capacitor module including at least one capacitor and connecting in parallel with the LED module; and
a constant current circuit connected in series in the power loop to maintain a constant value for a circuit current of the power loop.

2. The flicker-free LED driver circuit with a high power factor as claimed in claim 1, wherein the LED module is connected in series with a current restricting resistor and a current flowing through the current restricting resistor is not smaller than a lowest driving current of the LED module.

3. The flicker-free LED driver circuit with a high power factor as claimed in claim 1, wherein the LED light sources of the LED module are connected in series.

4. The flicker-free LED driver circuit with a high power factor as claimed in claim 2, wherein the LED light sources of the LED module are connected in series.

5. The flicker-free LED driver circuit with a high power factor as claimed in claim 1, wherein the LED light sources of the LED module are connected in parallel.

6. The flicker-free LED driver circuit with a high power factor as claimed in claim 2, wherein the LED light sources of the LED module are connected in parallel.

7. The flicker-free LED driver circuit with a high power factor as claimed in claim 1, wherein the LED light sources of the LED module are connected in both series and parallel.

8. The flicker-free LED driver circuit with a high power factor as claimed in claim 2, wherein the LED light sources of the LED module are connected in both series and parallel.

9. The flicker-free LED driver circuit with a high power factor as claimed in claim 3, wherein the capacitor module includes a plurality of capacitors connected in series.

10. The flicker-free LED driver circuit with a high power factor as claimed in claim 4, wherein the capacitor module includes a plurality of capacitors connected in series.

11. The flicker-free LED driver circuit with a high power factor as claimed in claim 5, wherein the capacitor module includes a plurality of capacitors connected in parallel.

12. The flicker-free LED driver circuit with a high power factor as claimed in claim 6, wherein the capacitor module includes a plurality of capacitors connected in parallel.

13. The flicker-free LED driver circuit with a high power factor as claimed in claim 7, wherein the capacitor module includes a plurality of capacitors connected in both series and parallel.

14. The flicker-free LED driver circuit with a high power factor as claimed in claim 8, wherein the capacitor module includes a plurality of capacitors connected in both series and parallel.

15. The flicker-free LED driver circuit with a high power factor as claimed in claim 1, wherein the capacitor module includes a plurality of capacitors respectively connected in parallel with the LED light sources of the LED module.

16. The flicker-free LED driver circuit with a high power factor as claimed in claim 2, wherein the capacitor module includes a plurality of capacitors respectively connected in parallel with the LED light sources of the LED module.

17. The flicker-free LED driver circuit with a high power factor as claimed in claim 1, wherein the constant current circuit comprises:
a voltage-controlled transistor connected in series in the power loop for adjusting the circuit current of the power loop and having a control end;
a current detection unit connected in series in the power loop to convert the circuit current in the power loop into a corresponding voltage signal;
a low frequency filter electrically connecting to the current detection unit and outputting an average voltage value according to the voltage signal converted by the current detection unit; and
a current regulating unit comprising:
a first input terminal electrically connected to the low frequency filter;
a second input terminal electrically connected to a reference voltage; and
an output terminal electrically connected to the control terminal of the voltage-controlled transistor;
wherein the current regulating unit compares the reference voltage with the average voltage value, and accordingly outputs a control signal to the control terminal of the voltage-controlled transistor, thereby stabilizing the circuit current of the power loop.

18. The flicker-free LED driver circuit with a high power factor as claimed in claim 2, wherein the constant current circuit comprises:
a voltage-controlled transistor connected in series in the power loop for adjusting the circuit current of the power loop and having a control end;
a current detection unit connected in series in the power loop to convert the circuit current in the power loop into a corresponding voltage signal;
a low frequency filter electrically connecting to the current detection unit and outputting an average voltage value according to the voltage signal converted by the current detection unit; and
a current regulating unit comprising:
a first input terminal electrically connected to the low frequency filter;
a second input terminal electrically connected to a reference voltage; and
an output terminal electrically connected to the control terminal of the voltage-controlled transistor;
wherein the current regulating unit compares the reference voltage with the average voltage value, and accordingly outputs a control signal to the control terminal of the voltage-controlled transistor, thereby stabilizing the circuit current of the power loop.
